(19) United States
(12) Patent Application Publication
(10) Pub. No.: US 2009/0081506 A1
(43) Pub. Date: Mar. 26, 2009

(54) FUEL CELL

(75) Inventor: Mingzi Hong, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/178,768

(22) Filed: Jul. 24, 2008

(30) Foreign Application Priority Data
Sep. 21, 2007 (KR) 2007-97036

(51) Int. Cl. H01M 8/04

(52) U.S. Cl. 429/26

(57) ABSTRACT

A fuel cell that can prevent an electricity generating units from being supplied with air from the outside after operation of the fuel cell is complete by shutting off air inlets formed on a case assembly. The fuel cell maintains the performance of the electricity generating units and is easily handled and stored. The fuel cell includes: a fuel cell body including at least one electricity generating unit, centering membrane-electrode assemblies and arranging anode and cathode portions on both sides of the membrane-electrode assemblies, configured to generate electrical energy by the reaction of fuel with oxygen; a case assembly configured to form air inlets that admit air to be supplied to the fuel cell body and to embed the fuel cell body so as to enable the cathode portion to face the air inlets; and shut-off units configured to shut off the air inlets of the case assembly.

### CROSS-REFERENCE TO RELATED APPLICATIONS

This application claims the benefit of Korean Application No. 2007-97036, filed Sep. 21, 2007 in the Korean Intellectual Property Office, the disclosure of which is incorporated herein by reference.

### BACKGROUND OF THE INVENTION

1. Field of the Invention

Aspects of the present invention relate to a fuel cell, and more particularly, to a fuel cell that can prevent electricity generating units from being supplied with air from the outside by shutting off air inlets formed in the fuel cell case assembly after the fuel cell has completed operation. Therefore, the performance of the electricity generating unit is maintained and the fuel cell is easily handled and stored.

2. Description of the Related Art

A fuel cell is an electric power system that directly converts into electrical energy the energy of a chemical reaction of an oxidant with hydrogen contained in hydrocarbon-based materials such as methanol, ethanol and natural gas. The types of fuel cells include a polymer electrolyte membrane fuel cell (hereinafter, referred to as “PEMFC”) system and a direct methanol fuel cell (hereinafter, referred to as “DMFC”) system.

Generally, a PEMFC system includes an electrode stack for generating electrical energy through a reaction of hydrogen (H₂) with oxygen (O₂) and a reformer for reforming fuel to generate the hydrogen. The PEMFC system has an advantage in that it has a high energy density and a high power, but it is necessary to handle the hydrogen with care and it requires related facilities such as a fuel reforming device for reforming the fuel gas (e.g., methane, methanol and natural gas) in order to produce the hydrogen.

On the other hand, a DMFC system directly supplies the electrode stack with methanol fuel and oxygen as an oxidant and generates electricity by an electrochemical reaction thereof. A DMFC system has an extremely high energy density and a high power density. A DMFC system directly uses liquid fuel such as methanol. Accordingly, a DMFC system does not require any related facilities such as a fuel reformer, thereby allowing the fuel to be easily stored and supplied.

In a DMFC system, the electrode stack actually generating the electricity is formed by laminating one or more unit cells including a membrane-electrode assembly (hereinafter, referred to as “MEA”) and a separator (or bipolar plate). The MEA is formed by interposing an electrolyte membrane between an anode electrode and a cathode electrode. Further, each structure of the anode and cathode electrodes includes a diffusion layer for supplying and diffusing the fuel, a catalyst layer in which an oxidation/reduction reaction of the fuel occurs, and an electrode support.

A DMFC system can be formed in different ways according to the arrangement and structures of the unit cells and air supply methods. In a monopolar type several unit cells are arranged in a plane. With this arrangement, a cathode electrode can be exposed to the air and each of the unit cells is supplied with air by natural diffusion or convection. The monopolar type does not use any pump for supplying air. Accordingly, the monopolar type is called a passive type or a semi-passive type.

Typically, a monopolar type-fuel cell uses air supplied by natural convection through an air supply hole formed on the case assembly of the fuel cell. However, it is desirable to block the air that is supplied to the stack when the fuel cell is not operating. If the stack continues to be supplied with air after the fuel cell has completed operation, the internal humidity of the stack decreases and thus the performance of the stack is lowered. Therefore, unnecessary reactions occur inside the stack. Since an active type-fuel cell is supplied with air through an air pump or blower, air supply to the stack can be prevented by stopping the operation of the air pump or blower. However, since the passive or semi-passive type-fuel cell is supplied with air by natural convection, it is more difficult to stop the air supply.

One inefficient way to address this problem is to separate the fuel cell from the stack when operation of the fuel cell is complete and to seal and store the fuel cell. Then, the fuel cell needs to be fitted in the stack again when it is time to restart the stack.

### SUMMARY OF THE INVENTION

Accordingly, aspects of the present invention provide a fuel cell that can prevent one or more electricity generating units from being supplied with air from the outside after the fuel cell has completed operation by shutting off air inlets formed in the fuel cell case assembly. Therefore, the performance of the electricity generating units is maintained and the fuel cell is easily handled and stored.

An aspect of the present invention provides a fuel cell that includes: a fuel cell body including at least one electricity generating unit configured to generate electrical energy by the reaction of fuel with oxygen by centering at least one membrane-electrode assembly and arranging corresponding anode and cathode portions on respective sides of the membrane-electrode assembly; a case assembly configured to form a plurality of air inlets that pass through outside air so as to be supplied to the fuel cell body and to orient the fuel cell body so as to enable the cathode portion to face the air inlets; and at least one shut-off unit configured to shut off the air inlets of the case assembly.

The fuel cell body may include a first surface and a second surface. The electricity generating units may be arranged respectively facing the first and second surfaces in the direction of the long side edge. The case assembly may include a first case part for surrounding the first surface of the fuel cell body and a second case part for surrounding the second surface thereof. The shut-off units may be formed respectively on the first and second case parts. A plurality of air inlets may be formed in regions that correspond to the regions where the electricity generating units are arranged in the case assembly, and may be formed at intervals that correspond to the diameter or width of the air inlets along the direction of the long side edge of the case assembly.

Each shut-off unit may include: at least one shut-off plate formed into a plate shape and formed at the corresponding air inlets; supporting blocks formed on upper and lower portions of the corresponding shut-off plates; supporting bars coupled to the corresponding supporting blocks and configured to support the shut-off plates to be movable to an inner side of the case assembly; and a moving bar, coupled to the supporting blocks, configured to move the shut-off plates along the supporting bars.

The shut-off plates may be formed toward the inner side of the first and second case parts facing the first and second surfaces, respectively. Further, the shut-off plates may be formed y corresponding to the number of regions in the electricity generating units. Further, each supporting block may include a coupling inlet into which the supporting bar is inserted.

The case assembly may include an upper plate hole in the upper plate. The moving bar may further include an operating bar that is formed into a block shape and that protrudes from one side toward the upper portion and from the upper side through the upper plate hole. The upper plate hole may be formed with a width that corresponds to the sum of the width of the operating bar and the diameter or width of an air inlet. The upper plate hole may be formed to contact the operating bar to one side thereof when the air inlets are shut off by the shut-off units. The operating bar has an operating terminal that is formed on at least one side thereof. The case assembly may include a case assembly terminal on at least one side of the upper plate hole so as to be electrically coupled when the operating bar contacts one side of the upper plate hole.

Each moving bar includes: an extending portion that extends from one side thereof so as to contact the inner surface of one side of the case assembly when the air inlets are shut off by the shut-off units; and a moving unit, coupled to the extending portion, configured to move the moving bar from one side to the other side. An idler gear is formed on the extending portion of the moving bar, and the moving unit may include an operating motor, a motor shaft coupled to the operating motor and a driving gear formed on one end portion of the motor shaft and configured to drive the idler gear. The extending portion has an operating terminal at the end thereof, and the case assembly may include a case assembly terminal that is formed in the region that contacts the end of the extending portion.

The fuel cell body may include a mid plate with at least one unit region to which a corresponding region of an electricity generating unit is coupled. Such region of an electricity generating unit may include: an anode portion that is tightly attached to the respective unit region and forms a fuel flow path; a membrane-electrode assembly that is tightly attached to the respective anode portion; and a cathode portion that has an air flow path for air ventilation and is attached to the respective membrane-electrode assembly.

The mid plate may include a supply path formed in the inner lower side and configured to supply the un-reacted fuel, and a discharge path formed in the upper portion and configured to discharge the reacted fuel to the outside. The unit region may include: a coupling groove to which the corresponding regions of the electricity generating units are coupled; an inlet formed on the lower portion inside the coupling groove and coupled with the supply path; and an outlet formed on the upper portion and coupled to the discharge path.

Each anode portion may include: an anode collector plate that is formed with a metal plate and coupled to the unit region, and has a fuel flow path coupled with the inlet and the outflow hole; and an anode electrode terminal that extends from the anode collector plate to the upper and lower portion. The fuel flow path may include a plurality of paths that are arranged in parallel with each other at predetermined intervals entirely in meander shapes. Each cathode portion may include a cathode collector plate formed with an electrical conductive metal plate and including a plurality of air flow paths, and a cathode electrode terminal that is formed to extend from the cathode collector plate to the upper and lower portion. Further, the air flow path may include a plurality of holes.

The fuel cell body is formed into a plate shape and may further include an opening portion formed in the region that corresponds to the region where the electricity generating unit is formed, and a supporting plate having a terminal groove that is formed into a groove shape on the upper or lower portion of the opening portion and to which an anode electrode terminal or a cathode electrode terminal is coupled. The fuel cell may further include a fuel pump configured to supply the fuel cell body with the fuel, and a fuel tank, coupled to the fuel pump, configured to store the fuel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating the structure of a fuel cell according to one example embodiment of the present invention;

FIG. 2 is an exploded perspective view of a fuel cell body with case assembly of the fuel cell of FIG. 1;

FIG. 3 is a detailed cross-sectional view of inset “A” of FIG. 2;

FIG. 4 is a perspective view of the case assembly of the fuel cell body of FIG. 2;

FIG. 5 is a front view of a mid-plate of the fuel cell body of FIG. 2;

FIG. 6 is a front view of an anode region of the fuel cell body of FIG. 2;

FIG. 7 is a front view of a cathode region of the fuel cell body of FIG. 2;

FIG. 8 is a front view of the case assembly and shut-off units of FIG. 2;

FIG. 9 is a cross-sectional view taken along line “D-D” of FIG. 8;

FIG. 10 is a detailed view of inset “C” of FIG. 8;

FIG. 11 is a front view of a case assembly and shut-off units of a fuel cell body according to another example embodiment of the present invention;

FIG. 12 is an expanded, detailed view of inset “D” of FIG. 11;

FIG. 13 is a front view illustrating when the shut-off units shut off an air inlet in the case assembly of FIG. 8; and

FIG. 14 is a cross-sectional view taken along line “E-E” of FIG. 13.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Further, as used herein, the term “form” and its grammatical analogs are used alternately to mean “shape” or “fabricate.” The meanings will be clear from the context. Neither meaning is limited to the particular shape described or any particular fabrication process

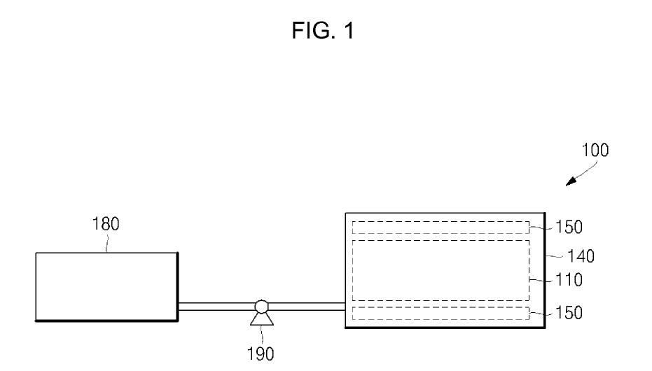

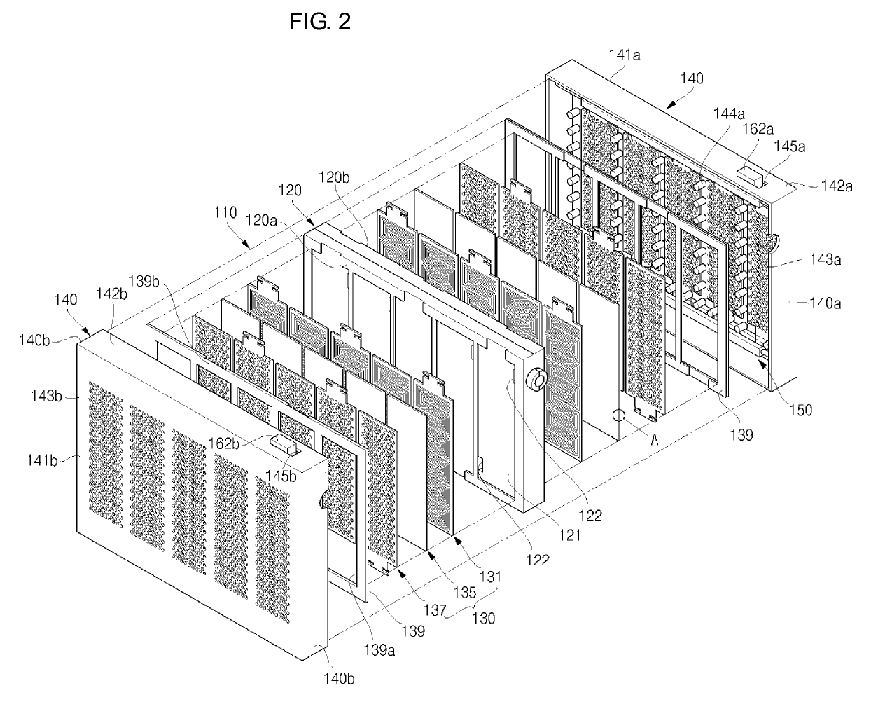

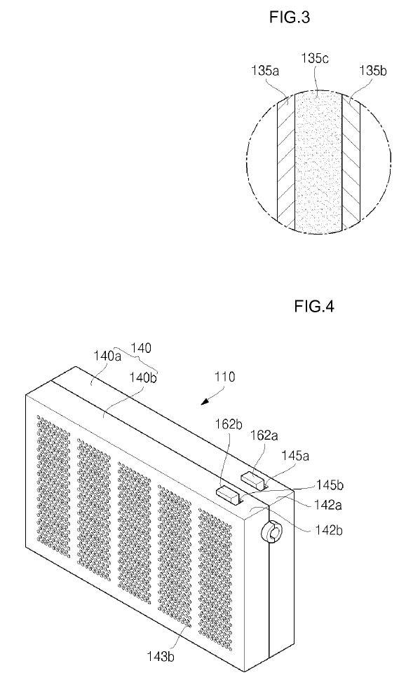

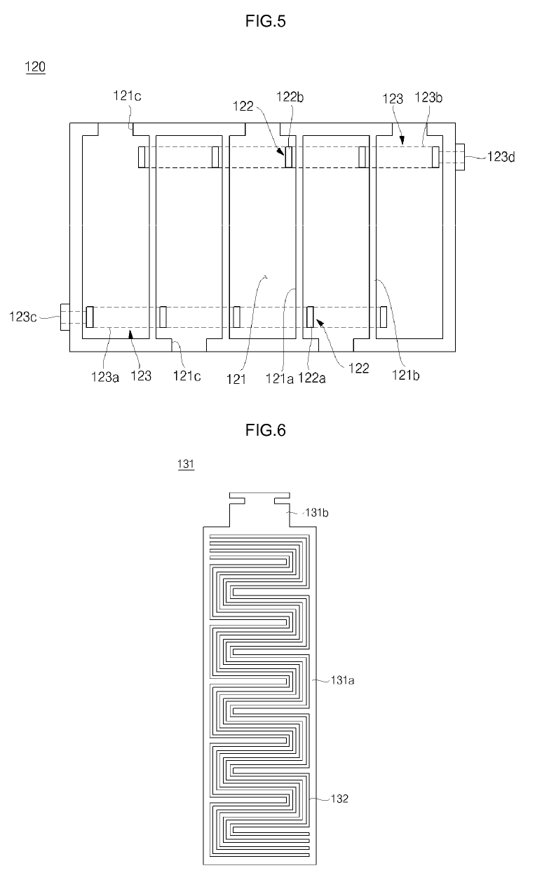

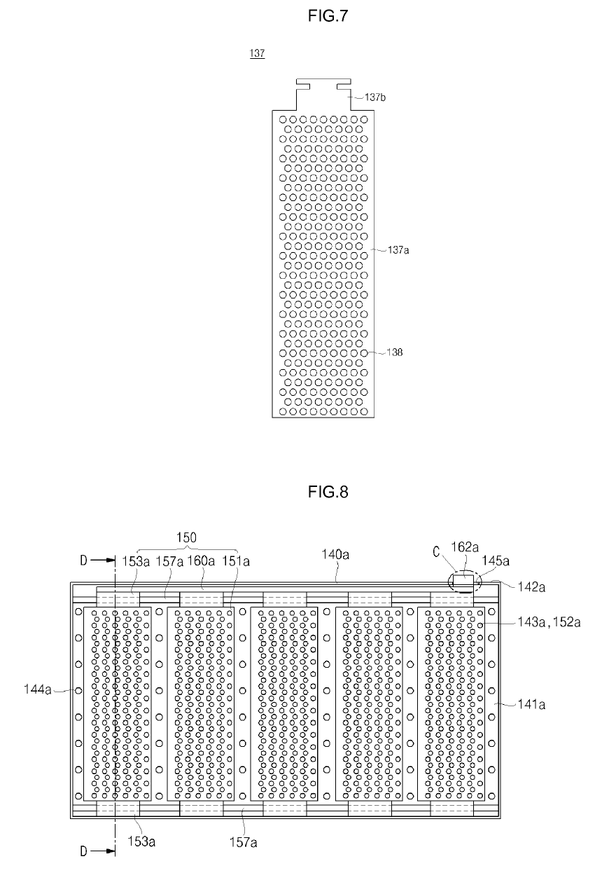

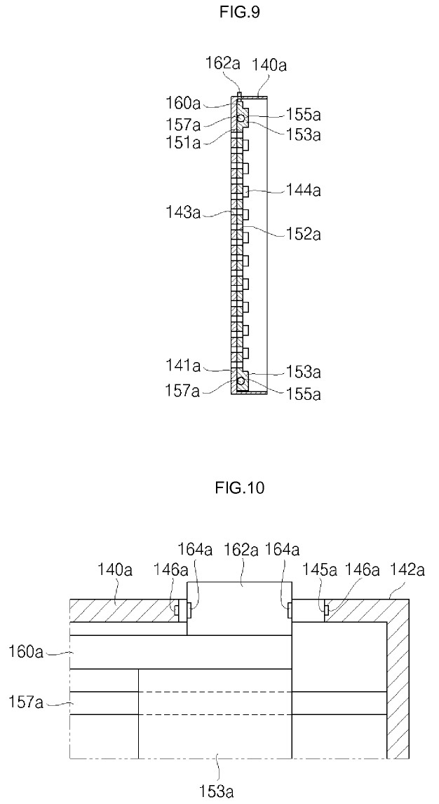

FIG. 1 is a schematic view illustrating the structure of a fuel cell according to one example embodiment of the present invention; FIG. 2 is an exploded perspective view of a fuel cell body with case assembly of the fuel cell of FIG. 1; FIG. 3 is a detailed cross-sectional view of inset “A” of FIG. 2; FIG. 4 is a perspective view of the case assembly of the fuel cell body of FIG. 2; FIG. 5 is a front view of a mid-plate of the fuel cell body of FIG. 2; FIG. 6 is a front view of an anode region of the fuel cell body of FIG. 2; FIG. 7 is a front view of a cathode region of the fuel cell body of FIG. 2; FIG. 8 is a front view of the case assembly and shut-off units of FIG. 2; FIG. 9 is a cross-sectional view taken along line “D-D” of FIG. 8; and FIG. 10 is a detailed view of inset “C” of FIG. 8.

Referring particularly to FIG. 1, a fuel cell 100 includes a fuel cell body 110, a case assembly 140 and a plurality of shut-off units 150. Further, the fuel cell 100 may include a fuel tank 180 and a fuel pump 190 for supplying the fuel cell body 110 with the fuel.

Fuel cell 100 is an electrical power system that outputs electrical energy generated by the electrochemical reaction of a fuel with oxygen to an electrical energy using device and is either coupled with the device through a cable or is mounted thereon as one body. Fuel cell 100 is a direct methanol fuel cell (DMFC) that is directly fed with alcohol-based fuel, such as methanol, ethanol and the like, and air, and generates electrical energy by an oxidation reaction of hydrogen contained in the fuel and a reduction reaction of oxygen contained in the air.

Fuel cell 100 is a monopolar plate type that in order to generate electrical energy is supplied with fuel by fuel tank 180 and fuel pump 190 and is supplied with air from the atmosphere by natural diffusion or convection. Further, since fuel cell 100 is supplied with air from the atmosphere by natural diffusion or convection, fuel cell 100 can also be classified as a passive or semi-passive type. A semi-passive type-fuel cell is supplied with fuel by fuel pump 190, while a passive type-fuel cell does not have an additional fuel pump 190 but is supplied with fuel by directly contacting the fuel with an anode electrode. Hereinafter, a semi-passive type-fuel cell will principally be described.

Referring to FIG. 2, fuel cell body 110 includes a mid-plate 120 and a plurality of electricity generating units 130 formed to face each other at both sides of the mid-plate 120. The fuel cell body 110 is the structure for generating electrical energy in electricity generating units by the reaction of fuel from mid-plate 120 and air supplied from the outside.

Mid-plate 120 includes at least one unit region 121, as well as a plurality of manifolds 122 and fuel paths 123 (also see FIG. 5). Mid-plate 120 is formed into an approximate plate shape fabricated from non-conductive insulating material. The shape of mid-plate 120 is a function of the number of regions of the electricity generating units 130, and the mid-plate 120 is formed into an approximate rectangular shape of which the length of the long edge direction is longer than that of the short edge direction. Mid-plate 120 has a first surface 120a and a second surface 120b, and acts both as a separator for electrically separating the electricity generating units 130 while supporting the electricity generating units 130 that are arranged on the first and second surfaces 120a and 120b. Further, the mid-plate 120 performs the function of fuel-supply to the electricity generating units 130 that are arranged on the first and second surfaces 120a and 120b.

Referring also to FIG. 5, one or more unit regions 121 are formed by dividing both surfaces of the mid-plate 120 at regular intervals along the long edge direction thereof, and are formed on the surface of the mid-plate 120 by a plurality of coupling grooves 121a. The unit regions 121 are formed as areas corresponding to those of the electricity generating units 130 (individual cells not separately numbered), so that the electricity generating units 130 are coupled to the coupling grooves 121a. Accordingly, the unit regions 121 are active regions where most of the reaction of the fuel and air supplied to the electric generating units 130 occurs. Each unit region 121 is distinguished from other unit regions 121 by a protrusion portion 121b formed adjacent to the corresponding coupling groove 121a.

The coupling grooves 121a are formed to a predetermined depth on both surfaces of the mid-plate 120, preferably to a depth corresponding to the height of respective anode portions 131 of the electricity generating units 130 that are arranged on the upper sides of the coupling grooves 121a. Further, the coupling grooves 121a include terminal grooves 121c that are formed on the upper or lower portion of the mid-plate 120.

Manifolds 122 are formed inside the coupling grooves 121a of the unit regions 121, and include inlets 122a for supplying the un-reacted fuel and outlets 122b for discharging the reacted fuel. Inlets 122a and outlets 122b are spaced apart from each other, so that the fuel supplied to the inside of unit regions 121 is entirely supplied to the electric generating units 130. Each pair of Inlets 122a and outlets 122b are preferably placed in a diagonal direction to each other inside a pair of coupling grooves 121a alongside a unit region 121.

Inlets 122a are preferably placed at the lower portions of the coupling grooves 121a so that the fuel is substantially used, and outlets 122b are placed at the upper portions of the coupling grooves 121a. Accordingly, the un-reacted fuel flowing into the inlets 122a reacts while passing through the entire length of each electricity generating unit 130. After that, the reacted fuel is discharged through outlets 122b, thereby improving the fuel usage efficiency.

The fuel paths 123 at least one supply path 123a and at least one discharge path 123b that are formed on the lower portion and upper portion of the mid-plate 120 and unit regions 121, respectively. The fuel path 123 may be formed inside the mid-plate 120 in a variety of manners. For example, the fuel path 123 may be formed by connecting two individual plates having coupling grooves 121a corresponding to the half portions of the fuel path 123 to the mid-plate 120. In another example, the fuel path 123 may be formed by creating a groove on each side of the mid-plate 120 formed as one body to the inside thereof. The fuel paths 123 supply the coupling grooves 121a of each of the unit regions 121 with the fuel supplied from an external fuel pump, and discharge the fuel passed through the electricity generating unit 130 to the outside.

One end of the supply path 123a is open toward the outside of the mid-plate 120 so as to form a supply hole 123c and the other end thereof is closed. The supply path 123a is coupled with the inlets 122a formed on the lower portion of the unit regions 121. Accordingly, the supply path 123a sequentially supplies the coupling grooves 121a with the un-reacted fuel supplied from the outside through each inlet 122a.

Similarly, one end of the discharge path 123b is open toward the outside of the mid-plate 120 so as to form a discharge hole 123d and the other end thereof is closed. The discharge path 123b is coupled with the discharge holes 122b formed on the upper portion of the unit regions 121. Accordingly, the supply path 123b sequentially discharges the reacted fuel coming from the coupling grooves 121a through the outlets 122b.

Referring to FIG. 6, the electricity generating units 130 include anode portions 131 arranged on each of the unit regions 121 of both surfaces 120a and 120b of the mid-plate, the membrane-electrode assemblies (hereinafter, referred to as “MEAs”) 135 arranged on the anode portions 131 and attached thereto and cathode portions 137 arranged on the MEAs 135 and attached thereto. Each electricity generating unit 130 has one or more unit cells that generate electrical energy by the reaction of the supplied fuel and air.

Each anode portion 131 includes an anode collector plate 131a and an anode electrode terminal 131b. The anode portions 131 act as guides that allow the un-reacted fuel that is to be supplied to flow entirely inside the corresponding coupling grooves 121a. Particularly, each anode portion 131 supplies a first electrode layer 135 of the MEA 135 with the un-reacted fuel by dispersion inside the corresponding coupling groovese 121a. Further, each anode portion 131 functions as a conductor that moves electrons separated from hydrogen contained in the fuel by the first electrode layer 135 to the cathode portion 137 of the respective electricity generating unit region of the electricity generating units 130.

Each anode collector plate 131a is formed from an electrically conductive metal plate, and has at least one fuel flow path 132 where the fuel flows. An anode collector plate 131a is attached to the first electrode layer 135a of an MEA 135 (see FIG. 3), and coupled to the corresponding coupling grooves 121a of the corresponding unit region 121 on both sides of the mid-plate 120.

Each fuel flow path 132 ends in a hole that penetrates the anode collector plate 131a and the fuel cell paths connect to the corresponding inlet 122a and the corresponding outlet 122b. The fuel flow paths 132 can be formed into various shapes particularly into meandering but parallel paths at predetermined intervals to each other. Each fuel flow path 132 allows the fuel supplied through the supply path 123a and the corresponding inlet 122a of the mid-plate 120 to flow into the corresponding first electrode layer 135a of an MEA 135.

An anode electrode terminal 131b is formed as one body with the corresponding anode collector plate 131a, and protrudes toward the upper or lower side of the mid-plate 120 and is supported by being inserted into a corresponding terminal groove 121c of the mid-plate 120. The anode electrode terminal 131b is electrically coupled with a cathode electrode terminal 137b by an additional connecting terminal (not shown).

Referring to FIG. 3, each MEA 135 includes a first electrode layer 135a on one surface thereof, and a second electrode layer 135b on the other surface, with an electrolyte membrane 135c between the first and second electrode layers 135a and 135b. The first electrode layer 135a may be formed into an anode electrode layer that separates electron and hydrogen ions from hydrogen contained in the fuel, the electrolyte membrane 135c then moves the hydrogen ions to the second electrode layer 135b, and the second electrode layer 135b may be formed into a cathode electrode layer that generates moisture and heat by reacting the electron and hydrogen ions received from the first electrode layer 135a and additionally fed oxygen. The MEA 135 is formed with a size corresponding to those of the anode and cathode portions 131 and 137 (discussed below), and may have a conventional gasket (not shown) in an edge portion thereof. The MEA 135 is arranged on a corresponding unit region 121 of the mid-plate so as to enable its first electrode layer 135a to be attached to an anode portion 131. The MEA 135 may be formed by typical methods used in the manufacture of direct methanol fuel cells (DMFCs). Those procedures will not be described in detail.

Referring to FIG. 7, each cathode portion 137 includes a cathode collector plate 137a and a cathode electrode terminal 137b. The cathode portion 137b is securely attached to a second electrode layer 135b of the MEA 135, and allows air to flow from the atmosphere by natural diffusion or convection so as to be dispersed in the MEA 135. The cathode portion 137 is formed with a size corresponding to that of the respective anode portion 131 or MEA 135. Further, the cathode portion 137 is electrically coupled with the anode portion 131 of the corresponding region of the electricity generating unit 130 neighboring on the same surface of the mid-plate 120 and the cathode portion 137 functions as a conductor that receives electrons.

A cathode collector plate 137a is formed with an electrically conductive metal plate, and has a plurality of air flow paths 138 into which the air flows. The cathode collector plate 137a may be made from gold, silver, copper and other metals having excellent electrical conductivity. Other metals may also be used by plating the surface thereof with gold, silver, copper and other metals having excellent electrical conductivity. The plurality of air flow paths 138 is formed into circular or polygonal shaped holes for penetrating the cathode collector plate 137a in order to effectively supply air by dispersion and to maintain the strength of the cathode collector plate.

A cathode collector plate 137a is formed as one body with the cathode electrode terminal 137b, and the terminal protrudes toward the upper or lower side of the mid-plate 120 while being inserted into a corresponding terminal groove 121c. The cathode electrode terminal 137b is electrically coupled with the corresponding anode electrode terminal 131b by an additional connecting terminal (not shown).

A plurality of supporting plates 139 (FIG. 2) is formed into a plane, and securely attaches the corresponding electricity generating unit 130 to the mid-plate 120 while contacting to the corresponding cathode portion 137. The supporting plates 139 include at least one open portion 139a and at least one terminal groove 139b. The open portion 139a is formed in a region corresponding to a region where an electricity generating unit cell of an electricity generating unit 130 is formed, and has an area corresponding to the region where the plurality of air flow paths 138 is formed in a cathode collector plate 137a. Each terminal groove 139b is formed with a size corresponding to the corresponding anode and cathode electrode terminals 131b and 137b, and the anode electrode and cathode terminals 131b and 137b are coupled thereto.

Referring as well to FIGS. 4 and 9, case assembly 140 includes a first case part 140a and a second case part 140b, both formed into an approximate box shape. Further, case assembly 140 includes a plurality of air inlets 143a and 143b and supporting protruberances 144a. Case assembly 140 receives the fuel cell body 110 thereinside. The case assembly 140 may further include upper plate holes 145a and 145b into which operating bars 162a and 162b of the corresponding shut-off unit 150 are inserted and which are capable of movement. Further, case assembly 140 may include an additional attachment member (not shown) between itself and the fuel cell body 110 in order to attach securely the mid-plate 120 to the electricity generating units 130.

FIGS. 8 and 9 illustrate the first case part 140a that forms part of case assembly 140. However, the second case part 140b is formed in the same way as the first case part 140a. Accordingly, although the structures shown in FIG. 8 are part of the first case part 140a, similar structures are part of the second case part 140b and have the same reference numbers except for the “a” or “b” if the second case part 140b were shown and described.

First case part 140a has a hollow interior, and is formed into a box shape in which one side or the other side is open. The first case part 140a is connected to the second case part 140b, thus forming an interior space to receive the fuel cell body 110 and the shut-off units 150. That is, the largest surface of the first case part 140a is a first flat plate that faces the fuel cell body 110 received inside thereof. Further, the case assembly 140 and the space inside receive the shut-off units 150 as well, because the shut-off units 150 are preferably mounted on the upper portion of the fuel cell body 110.

In the first case part 140a, a plurality of air inlets 143a is formed on the first flat plate 141a facing the fuel cell body 110. The plurality of air inlets 143a is formed in a region corresponding to the region where the respective electricity generating unit 130 is placed against the first flat plate 141a when the fuel cell body 110 is received inside of the first case part 140a. Atmospheric air flows into the plurality of air inlets 143a and then is supplied to that electricity generating unit 130. The plurality of air inlets 143a may be formed into various shapes, such as a circle, a square or a hexagon that penetrate the first flat plate 141a. The plurality of air inlets 143a is formed to be spaced apart from adjacent air inlets 143a. In particular, the air inlets 143a are spaced from the adjacent air inlets 143a at a distance larger than the diameter of the particular circular shape or the width of the square shape square of the air inlets 143a. Accordingly, the air inlets 143a can be shut off temporarily by a shut-off units 150.

A plurality of supporting protruberances 144a is in the shape of a bar or hemisphere, protruding vertically from the first flat plate 141a, on regions except those regions where the plurality of air inlets 143a is formed on the first flat plate 141a. Further, the plurality of supporting protruberances 144a is formed with a height corresponding to the distance between the case assembly 140 and the fuel cell body 110. The number of the supporting protuberances 144a is formed to be enough to support the fuel cell body 110. More particularly, the plurality of supporting protuberances 144a and 144b contacts the plurality of protrusion portions 121b formed on the periphery of the plurality of coupling grooves 121a of the mid-plate 120 so as to support the fuel cell body 110.

Upper plate hole 145a is formed on a region corresponding to the region where an operating bar 162a is formed in the upper plate 142a of the first case part 140a. The upper plate hole 145a is formed in a width corresponding to the moving distance of the operating bar 162a. Accordingly, the upper plate hole 145a limits the moving distance of the operating bar 162a, so that positions for completely opening and shutting off the plurality of air inlets 143a are limited thereto as described below.

Each shut-off unit 150 includes at least one shut-off plate 151a, at least one supporting block 153a, at least one supporting bar 157a and a moving bar 160a. Further, each shut-off unit 150 may further include the operating bar 162a. Each shut-off unit 150 moves the corresponding shut-off plate 151a so as to shut off the plurality of air inlets 143a formed on the case assembly 140 while the fuel cell is not operating. As described above, although shut-off units 150 of FIG. 8 are not shown in an equivalent front view of the second case part 140b of FIG. 4, at least one shut-off unit 150 is formed in the second case part 140b.

Each shut-off plate 151a is formed into an approximate plane shape. Further, each shut-off plate 151a is formed into a shape corresponding to a unit region. Accordingly, the number and shape of the shut-off plates 151a are the same as those of the plurality of electricity generating unit cells of electricity generating unit 130 that is formed on a surface of the fuel cell body 110. Further, each shut-off plate 151a is arranged at the same interval and in the same region as the respective unit cell of electricity generating unit 130. Further, each shut-off plate 151a is supported to be movable by the corresponding supporting block 153a in the inner side of the first case part 140a. Each shut-off plate 151a forms a plurality of shut-off holes 152a according to the shape and interval corresponding to the plurality of air inlets 143a formed on the case assembly 140. Accordingly, each shut-off plate 151a completely opens or shuts off the corresponding plurality of air inlets 143a while being moving by a distance that corresponds to the diameter or width of the corresponding plurality of air inlets 143a, so that the shut-off plates 151a can close off the inlet air.

The supporting blocks 153a are formed into pillars having a variety of shapes such as a square, a semicircle and other shapes. Each supporting block 153a is coupled respectively to the upper and lower ends of a shut-off plate 151a. Each supporting block 153a includes a coupling hole 155a formed along the moving direction thereof, that is, in the direction of the long side edge of the first case part 140a and the corresponding supporting bar 157a is inserted into a coupling hole 155a. Further, each supporting block 153a is supported at the inner side of the first case part 140a. Accordingly, each supporting block 153a is coupled to a supporting bar 157a and is movable, so that each shut-off plate 151a moves because it is attached to the inner surface of the first flat plate 141a.

The supporting bars 157a are formed into bars having a variety of shapes such as squares or circles, and are arranged on the upper and lower portions of the first case part 140a in the direction of the long side edge in the inner side of the first case part 140a and coupled thereto. Each supporting bar 157a may be supported respectively to its left and right sides and coupled to the first case part 140a. Further, each supporting bar 157a may be attached to the inner surface of the first flat plate 141a or spaced apart therefrom according to the shape of the corresponding supporting block 153a, the position of the coupling holes 155a and the coupling method. Each supporting bar 157a is inserted into the corresponding coupling hole 155a of the corresponding supporting block 153a so as to enable the supporting block 153a to move in the direction of the long side edge of the first case part 140a.

A moving bar 160a is formed into a bar having a variety of shapes such as a square circle, and is entirely coupled with the corresponding supporting blocks 153a that are coupled to the upper portions of of the corresponding shut-off plates 151a. The moving bar 160a moves a plurality of the shut-off plates 151a at the same time.

The operating bar 162a is formed into a block shape, and is coupled to one side of the moving bar 160a (right side of the first case part in FIG. 8) in order to protrude toward the outside of the first case part 140a through the upper plate hole 145a of the upper plate 142 of the first case part 140a. The operating bar 162a protrudes from the upper surface of the case assembly 140 far enough so that a user of the fuel cell can handle the fuel cell 100 with his/her own fingers. The operating bar 162a may be formed as one body with the moving bar 160a. The operating bar 162a is formed in a width corresponding to the length obtained by subtracting the length corresponding to the diameter or width of each air inlet 143a from the width of the upper plate hole 145a. Further, the operating bar 162a is coupled to the moving bar 160a so as to contact the inner surface of one side of the upper plate hole 145a when the plurality of air inlets 143a is shut off. Accordingly, when the operating bar 162a is at one side of the upper plate hole 145a, the shut-off plates 151a completely shut off the plurality of air inlets 143a. Further, when the operating bar 162a is placed to the left side, each shut-off hole 152a coincides with the an air inlet 143a, so that the shut-off plate 151a opens a plurality of air inlets 143a. In particular, the operating bar 162a is limited to moving to the position where the plurality of air inlets 143a can be completely shut-off or opened in accordance with the width of the upper plate hole 145a.

Referring to FIG. 10, an operating terminal 164a is formed on one side and/or the other one of the operating bar 162a, and electrically coupled to a controller (not shown) of the fuel cell through a separate cable. Accordingly, the operating terminal 164a is electrically contacted to a case assembly terminal 146a that is formed on the inner surface of one side and/or the other one of the upper plate hole 145a of the first case part 140a. If the operating terminal 164a and the case assembly terminal 146a are located on one side of each of the operating bar 162a and the upper plate hole 145a, respectively, the controller recognizes that the shut-off units 150 completely shut off the plurality of air inlets 143a when the operating terminal 164a and the case assembly terminal 146a are electrically in contact with each other. Further, if the operating terminal 164a and the case assembly terminal 146a are located on the other side of each of the operating bar 162a and the upper plate hole 145a, respectively, the controller recognizes that the shut-off units 150 completely open the plurality of air inlets 143a when the operating terminal 164a and the case assembly terminal 146a are electrically in contact with each other and operates the fuel cell normally. Further, when the operating terminal 164a and the case assembly terminal 146a are located on both sides of the operating bar at the same time, the controller can recognize simultaneously if the plurality of air inlets 143a is completely open or shut off. If the operating terminal 164a and the case assembly terminal 146a are not electrically in contact with each other, the controller of the fuel cell recognizes either that the air inlets 143a are not shut off completely or not open completely. Accordingly, the controller of the fuel cell 100 notifies the user through alarm units (not shown) such as an alarm lamp, a monitor display or other kinds of alarms.

Meanwhile, the operating terminal 164a and the case assembly terminal 146a may be formed by other methods except than described above. In particular, the operating terminal 164a may be located either at another position of the operating bar 162a or one position of the moving bar 160a, the at least one supporting block 153a and the at least one shut-off plate 151a. Further, the operating terminal 164a may be formed on an extension (not shown) that extends from the operating bar 162a, the moving bar 160a, the at least one supporting block 153a or the at least one shut-off plate 151a. In this case, the case assembly terminal 146a may be located at a position corresponding to the position where the operating terminal 164a of the first case part 140a is located in order to indicate the position where the plurality of air inlets 143a is completely open or shut.

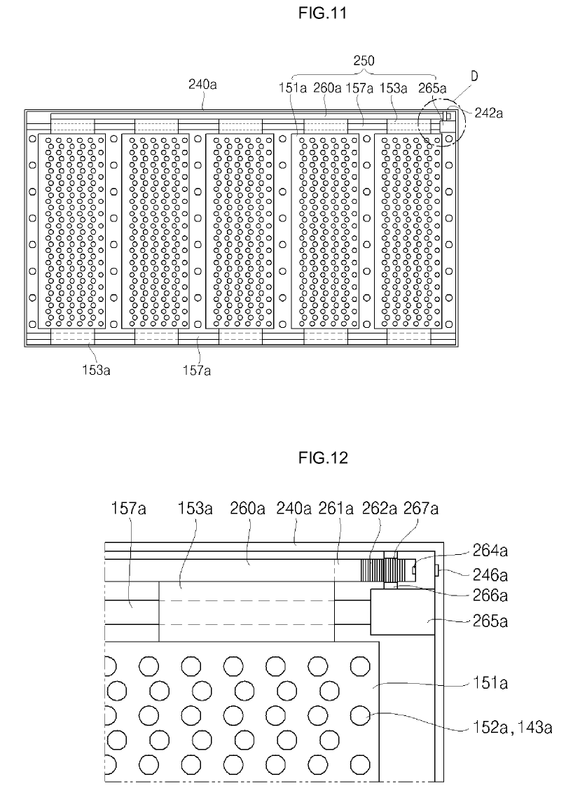

Hereinafter, a fuel cell according to another example embodiment of the present invention will be explained. FIG. 11 is a front view of a case assembly and shut-off units of a fuel cell body according to another example embodiment of the present invention, and FIG. 12 is an expanded, detailed view of inset “D” of FIG. 11. The fuel cell according to this example embodiment of the present invention will be explained focusing on differences from the embodiment of FIGS. 1 to 10. Accordingly, the fuel cell according to this example embodiment of the present invention uses the same drawing reference numerals as the embodiment of FIGS. 1 to 10. The same reference numerals will not be explained in detail hereinafter.

Referring to FIGS. 11 and 12, the fuel cell 100 includes a fuel cell body 110 (referring to FIG. 1), a case assembly 240 (like FIG. 4 but not shown) and shut-off units 250. Further, the fuel cell 100 may further include a fuel tank 180 (referring to FIG. 1) and a fuel pump 190 (referring to FIG. 1), which together supply fuel to the fuel cell body 110. Since the fuel cell body 110 is the same as described above, the explanation specific for this example embodiment will be omitted.

Case assembly 240 includes a first case part 240a and a second case part (not shown, but like FIGS. 2 and 4. The first case part 240a includes a plurality of air inlets 143a and a plurality of supporting protruberances 144a. As described above, FIGS. 11 and 12 illustrate the first case part 240a included in the case assembly 240. However, the second case part is also formed in the same manner. Accordingly, although the structures shown in FIGS. 11 and 12 are part of the first case part 240a, similar structures are part of the second case part and would have the same reference numbers if the second case part 240b were shown and described.”

The first case part 240a is like the first case part 140a according to the first example embodiment of the present invention, except that no upper plate hole is formed on the upper plate 242a of the first case part 240a. Further, a case assembly terminal 246a is formed on the inner side of one side of the first case part 240a. The case assembly terminal 246a is electrically connected to an operating terminal 264a as described below, so as to enable a controller of the fuel cell 100 to determine whether the plurality of air inlets 143a is shut off or not.

Referring to FIG. 11, the at least one shut-off unit 250 includes at least one shut-off plate 151a, at least one supporting block 153a, at least one supporting bar 157a, a moving bar 260a and an operating motor 265a. Further, the at least one shut-off unit 250 includes an operating terminal 264a (see FIG. 12) formed on the end of the moving bar 260a.

The moving bar 260a is a bar in a shape such as a square or round, and entirely coupled with the at least one supporting block 153a that is coupled to the upper portion of the at least one shut-off plate 151a. The moving bar 260a moves all of the shut-off plates 151a at the same time.

Referring to FIG. 12, the moving bar 260a includes an extension portion 261a, an idler gear 262a and an operating terminal 264a. The extension portion is extended from the moving bar 260a to the right side of the supporting blocks 153a of the shut-off plates 151a placed on the right side. Further, the extension portion 261a extends to contact the inner side of the right side of the first case part 240a when the shut-off plates 151a completely shut off the plurality of air inlets 143a. Accordingly, the extension portion 261a limits the moving distance of the shut-off plates 151a so that the plurality of air inlets 143a is completely shut off by the shut-off plates 151a.

The idler gear 262a is formed on the surface facing the fuel cell body 110 in the extension portion 261a. Accordingly, the idler gear 262a is coupled with a driving gear 267a of the operating motor 265a so as to move the moving bar 260a to the right and left. The idler gear 262a may be formed either on the extension portion 261a or with an additional gear and coupled with the driving gear.

The operating terminal 264a is formed on the end of the extension portion 261a, so that it is in electrical contact with the case assembly terminal 246a formed on the inner side of the first case part 240a when the extension portion 261a is in contact with the inner side of one side of the first case part 240a. Accordingly, the controller of the fuel cell senses any electrical connection between the operating terminal 246a and the case assembly terminal 246a and determines that the plurality of air inlets 143a is completely shut off.

The operating motor 265a includes the driving gear 267a formed on a motor shaft 266a, and fixed between sides of the fuel cell body 110 and the first case part 240a in the inner side of the first case part 240a. Further, the motor shaft 266a is coupled to the upper plate 242a of the first case part 240a so as to be supported. The operating motor 265a moves the moving bar 260a by connecting the driving gear 267a with the idler gear 262a of the extension portion 261a. The operating motor 265a is driven and controlled according to the rotation required for the moving distance of the moving bar 260a. Accordingly, the operating motor 265a opens the plurality of air inlets 143a by moving the shut-off plates 151a when the fuel cell is operated, and controls the moving distance of the moving bar 260a of the shut-off plates 151a by controlling the rotation of the driving gear 267a. Further, the operating motor completely shuts off the plurality of air inlets 143a by moving the shut-off plates 151a again when the operation of the fuel cell is stopped so as to prevent the fuel cell body 110 from being supplied with air. The operating motor 265a controls the rotation of the driving gear 267a, so that the moving distance of the shut-off plates 151a is controlled. In this way, the moving bar 260a limits the moving distance of the shut-off plates 151a so as to act as a limit switch. The moving distance of the moving bar 260a is determined according to optional extras of the driving gear 267a and the idler gear 262a formed on the extension portion 261a of the moving bar 260a, and these will be not described in detail hereinafter.

Meanwhile, the extension portion 261a of the moving bar 260a, the idler gear 262a and the operating terminal 264a, all of which form the shut-off units 250, may be located in another position according to the construction of the case assembly and the fuel cell body 110. Further, the operating motor 265a may be located in another position according to the construction of the case assembly and the fuel cell body 110.

In addition, the shut-off units 150 located on the case assembly 140 (or shut-off units 250 in this embodiment) may also be located on a separate external case assembly (not shown) for receiving the fuel cell in the same manner. In particular, when the case assembly 140 is received in an external case assembly, the shut-off units 150 may be located on the external case assembly.

Further, the embodiments according to the present invention are described focusing on the semi-passive type-fuel cell in which fuel is supplied by the fuel pump. However, the shut-off units 150 according to aspects of the present invention can be applied to the passive type-fuel cell in the same manner. That is, in the passive type-fuel cell a fuel space is formed that is supplied directly with fuel on the side of anode electrodes 131 of the electricity generating units 130. The passive type-fuel cell maintains the status that fuel is supplied to the fuel space in contact with a first electrode 135a simply through the anode electrodes 131. Accordingly, in the passive type fuel cell the first electrodes 135a of MEAs 135 are continuously supplied with the unreacted fuel in the same way as in a semi-passive type-fuel cell.

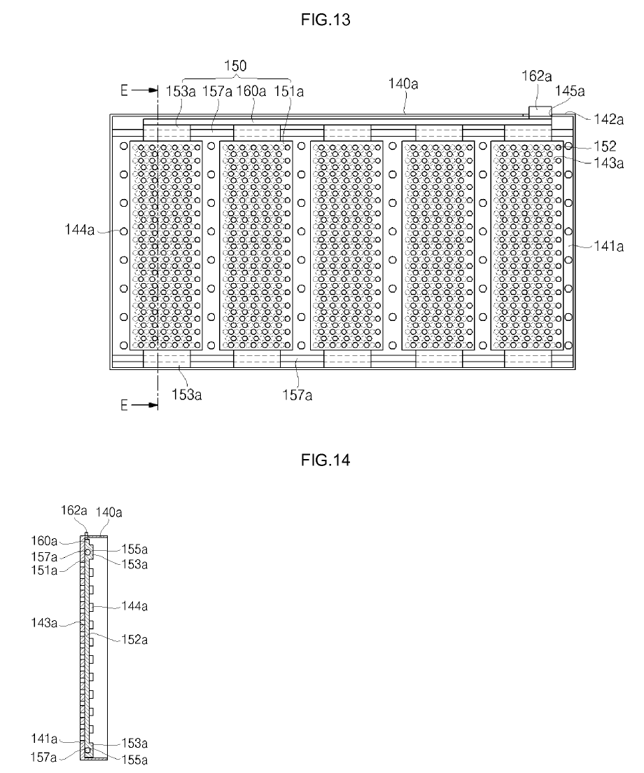

Hereinafter, operation of a fuel cell 100 according to embodiments of the present invention will be explained. FIG. 13 is a front view illustrating when the shut-off unit shuts off a plurality of air inlets in the case assembly of FIG. 8, and FIG. 14 is a cross-sectional view taken along line “E-E” of FIG. 13. The operation of the fuel cell 100 according to FIGS. 1 to 10 will be principally explained. However, if necessary, the fuel cell according to the embodiment of FIGS. 11 and 12 will additionally be explained.

The fuel cell 100 is coupled to a predetermined electric or electronic device by a cable or is mounted thereon as one body. The fuel cell 100 shuts off the plurality of air inlets 143a by the shut-off units 150 after operation of the device is completed. The fuel cell 100 moves a plurality of the shut-off plates 151a at the same time by moving the moving bar 160, so that the plurality of air inlets 143a is shut off. The moving bar 160 may be moved manually by the operating bar 162a as shown in FIG. 8. Further, the moving bar 260a may be moved automatically by the operating motor 265a as shown in FIG. 11. The fuel cell 100 determines whether the plurality of air inlets 143a is completely shut off or not according to whether the operating terminal 164a formed on one side thereof is in contact with the case assembly terminal 146a or not. That is, the fuel cell 100 minimizes additional reactions occurring in the fuel cell body 110 when the operation of the fuel cell 100 is completed by blocking air inflow.

If the operation of the fuel cell 100 is necessary, the fuel cell 100 moves the moving bar 160a and the shut-off plate plates 151a so as to open the air inlets 143a. The fuel cell 100 opens the air inlets 143a by moving the moving bar 160a in the other direction from the shut-off status of the air inlets 143a. The fuel cell 100 also determines whether the air inlets 143a and 143b are completely shut off or not according to whether the operating terminal 164a formed on the other side of the first case part is in contact with the case assembly terminal 146a or not.

The fuel cell 100 exposes the cathode portion 137 of the respective electricity generating region of electricity generating unit 130 to the atmosphere by opening the air inlets 143a and 143b when the operation of the fuel cell 100 is initiated. The fuel cell 100 is supplied with fuel by connecting the fuel cell body 110 to the fuel tank 180 and the fuel pump 190. The mid-plate 120 supplies the at least one unit region 121 with the fuel through the supply path 123a and the plurality of inlets 122a that are formed on the inner lower side thereof. The anode portion 131 of the respective electricity generating region of electricity generating unit 130 supplies the respective first electrode layer 135a of the respective MEA 135 with the fuel supplied to the unit region by dispersion. The fuel supplied to the first electrode layers 135a is discharged to the outside of the unit regions 121 through the outlets 122a and the at least one discharge path 123b that are formed on the upper portion of the mid-plate 120. Particularly, the fuel supplied to the unit regions 121 rises from the lower side to the upper side along the fuel paths 132 and is used for the reaction for generating electrical energy in the electricity generating units 130. Meanwhile, the plurality of electricity generating units 130 coupled to the mid-plate 120 are supplied with the fuel through the inlets 122a coupled to the supply paths 123a. Further, the electricity generating units 130 discharge the reacted fuel to the outside of the mid-plate 120 through the outlets 122b coupled to the discharge paths 123b.

Meanwhile, the cathode portions 137 of the electricity generating regions of the electricity generating units 130 are exposed to the atmosphere and supplied with air from the outside by natural diffusion or convection. Accordingly, the air supplied to the cathode portions 137 is supplied to the respective second electrode layers 135b of the respective MEAs 135 through the air flow paths 138 by dispersion.

In this way, electrons and hydrogen ions (protons) are separated from hydrogen contained in the fuel by an oxidation reaction of the fuel in the first electrode layers 135a of the MEAs 135. The hydrogen ions are moved to the second electrode layers 135b through the electrolyte membranes 135c of the MEAs 135. The electrons cannot pass through the electrolyte membranes 135c, but are moved to the cathode portions 137 of the electricity generating regions of the electricity generating units 130 that are electrically coupled with the respective anode portions 131, through the anode portions 131 being electrically contacted to the respective first electrode layers 135a. Particularly, since the anode portions 131 are electrically coupled with the cathode portions 137 of the electricity generating regions of the electricity generating units 130 of the respective unit regions 121 through an additional connecting terminal or a cable, the electrons are moved to the cathode portions 137 of the respective generating regions of the electricity generating units 130 through the anode portions 131.

Further, the hydrogen ions moved to the second electrode layers 135b from the first electrode layers 135a of the MEAs 135 through the electrolyte membranes 135c, the electrons moved to the cathode portions 137 through the anode portions 131, and the air supplied to the second electrode layers 135b of the MEAs 135 through the air flow paths 138 of the cathode portions 137 are subjected to a reduction reaction by the second electrode layers 135b. Accordingly, the cathode portions 137 of the electricity generating regions of the electricity generating units 130 generate heat and moisture through the reduction reaction.

Through the above-described processes, the fuel cell 100 generates electric currents due to the movement of the electrons, and the anode and cathode portions 131 and 137 of the electricity generating regions of the electricity generating units 130 function as the collector plates for collecting the electric currents so as to output electrical energy having a predetermined electric potential difference to the electrical or electronic device.

The fuel cell 100 prevents air inflow from the outside by shutting off the plurality of air inlets 143a and 143b again according to the above-described processes when the operation of the fuel cell is completed.

As described above, the fuel cell according to aspects of the present invention has the following effects. First, the fuel cell prevents the electricity generating units from being supplied with air from the outside by shutting off the air inlets formed in the case assembly after completing operation of the fuel cell, thereby stopping additional reaction in the electricity generating units, and thus allowing the performance of the electric generating units to be well maintained. Second, the electricity generating units are isolated from the outside so as to prevent moisture from flowing to the outside, thereby preventing the membrane-electrode assemblies from drying out. Third, the fuel cell does not need to be additionally sealed to maintain it after it has completed operation, thereby allowing it to be easily handled and kept.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell comprising:
a fuel cell body comprising at least one electricity generating unit, centering membrane-electrode assemblies on regions of the electricity generating units, arranging anode and cathode portions on both sides of the membrane-electrode assemblies and generating electrical energy by the reaction of fuel with oxygen;
a case assembly having a plurality of air inlets that pass air through to the fuel cell body and embedding the fuel cell body so as to enable the cathode portions to face the air inlets; and
at least one shut-off unit shutting the plurality of air inlets.

2. The fuel cell of claim 1, wherein the fuel cell body comprises a first surface and a second surface, the electricity generating units are arranged respectively on the first and second surfaces in the direction of the long side edge, the case assembly comprises a first case part for surrounding the first surface of the fuel cell body and a second case part for surrounding the second surface thereof, and the shut-off units are formed respectively on the first and second case parts.

3. The fuel cell of claim 2, wherein the plurality of air inlets is formed on regions that correspond to the regions of the electricity generating units arranged in the case assembly, and is formed at intervals that correspond to the diameter or width of the air inlets along the direction of the long side edge of the case assembly.

4. The fuel cell of claim 2, wherein each shut-off unit comprises:
at least one shut-off plate formed into a plate shape and formed at the corresponding air inlets;
supporting blocks corresponding to each shut-off plate and formed on upper and lower portions of the corresponding shut-off plate;
a supporting bar coupled to each supporting block and supporting the corresponding shut-off plate to be movable to an inner side of the case assembly; and
a moving bar coupled to the supporting blocks and configured to move the shut-off plates along the supporting bars.

5. The fuel cell of claim 4, wherein the shut-off plates are formed to the inner side of the first and second case parts facing the first and second surfaces, respectively.

6. The fuel cell of claim 4, wherein the each shut-off plate corresponds to a region of region of an electricity generating unit.

7. The fuel cell of claim 4, wherein each supporting block further comprises coupling hole into which the corresponding supporting bar is inserted.

8. The fuel cell of claim 4, wherein the case assembly contains an upper plate hole on the upper plate, and the moving bar further comprises an operating bar that is formed into a block shape and protrudes from one side of the moving bar toward the upper portion and protrudes from the upper side through the upper plate hole.

9. The fuel cell of claim 8, wherein the upper plate hole is formed with a width that corresponds to the sum of the width of the operating bar and the diameter or width of an air inlet.

10. The fuel cell of claim 8, wherein the upper plate hole is formed to contact the operating bar to one side thereof when the plurality of air inlets is shut off by the at least one shut-off unit.

11. The fuel cell of claim 8, wherein the operating bar comprises an operating terminal that is formed on at least one side thereof, and the case assembly includes a case assembly terminal on at least one side of the upper plate hole so as to be electrically coupled when the operating bar is in contact with one side of the upper plate hole.

12. The fuel cell of claim 4, wherein the moving bar comprises:
an extending portion that extends from one side thereof so as to contact the inner surface of one side of the case assembly when the plurality of air inlets is shut off by the at least one shut-off unit; and
a moving unit, coupled to the extending portion, configured to move the moving bar from one side of the upper plate hole to the other side.

13. The fuel cell of claim 12, further comprising an idler gear formed on the extending portion of the moving bar, and the moving unit comprises an operating motor, a motor shaft coupled to the operating motor and a driving gear, formed on one end portion of the motor shaft and driving the idler gear.

14. The fuel cell of claim 12, wherein the extending portion comprises an operating terminal at the end thereof, and the case assembly comprises a case assembly terminal that is formed in the region that is in contact with the end of the extending portion.

15. The fuel cell of claim 1, wherein the fuel cell body comprises a mid plate including a plurality of unit regions to which each region of an electricity generating units is coupled, each region of an electricity generating unit comprising:
an anode portion that is formed to be tightly attached to the region of the electricity generating unit and forms a fuel flow path;
a membrane-electrode assembly that tightly attached to the corresponding anode portion; and
a cathode portion that has a plurality of air flow paths for air ventilation wherein the cathode portion is attached to the corresponding membrane-electrode assembly.

16. The fuel cell of claim 15, wherein the mid plate comprises a supply path, formed on the inner lower side, configured to supply the un-reacted fuel, and a discharge path, formed on the upper portion, configured to discharge the reacted fuel to the outside, and the regions of the plurality of electricity generating units comprise: coupling grooves to which the regions of the plurality of electricity generating units are coupled; an inlet formed on the lower portion inside the coupling grooves and coupled with the supply path; and an outlet formed on the upper portion and coupled to the discharge path.

17. The fuel cell of claim 16, wherein each anode portion comprises:
an anode collector plate that is formed with a metal plate, coupled to the respective electricity generating unit region, and has a fuel flow path to be coupled with the inlet and the outflow holes; and
an anode electrode terminal that extends from the anode collector plate to the upper and lower portion.

18. The fuel cell of claim 17, wherein the fuel flow path comprises a plurality of paths that are arranged in meandering and parallel paths with at predetermined intervals to each other.

19. The fuel cell of claim 15, wherein each cathode portion comprises a cathode collector plate, formed with an electrically conductive metal plate, including a plurality of air flow paths and a cathode electrode terminal that is formed to extend from the cathode collector plate to the upper and lower portion.

20. The fuel cell of claim 19, wherein the plurality of air flow paths is formed with a plurality of holes.

21. The fuel cell of claim 15, wherein the fuel cell body is formed into a plate shape and further comprises an opening portion formed in the region corresponding to the region where the plurality of electricity generating units is formed, and a supporting plate having at least one terminal groove on the upper or lower portion of the opening portion and to which each anode electrode terminal or a cathode electrode terminal is coupled.

22. The fuel cell of claim 1, further comprising a fuel pump configured to supply the fuel cell body with the fuel, and a fuel tank, coupled to the fuel pump, configured to store the fuel.
